(19) United States
(12) Patent Application Publication
(10) Pub. No.: US 2024/0212922 A1
(43) Pub. Date: Jun. 27, 2024

(54) COIL COMPONENT

(71) Applicant: SAMSUNG ELECTRO-MECHANICS CO., LTD., Suwon-si (KR)

(72) Inventors: Jong Pil LEE, Suwon-si (KR); Seok Hwan AHN, Suwon-si (KR); No Il PARK, Suwon-si (KR); A Reum KIM, Suwon-si (KR)

(73) Assignee: SAMSUNG ELECTRO-MECHANICS CO., LTD., Suwon-si (KR)

(21) Appl. No.: 18/386,055

(22) Filed: Nov. 1, 2023

(30) Foreign Application Priority Data
Dec. 21, 2022 (KR) 10-2022-0180364

(51) Int. Cl. H01F 27/29; H01F 17/00; H01F 27/30

(52) U.S. Cl. CPC H01F 27/292; H01F 17/0013; H01F 27/306

(57) ABSTRACT

A coil component includes: a body including a core, and a first surface and a second surface opposing each other in a first direction, a third surface and a fourth surface opposing each other in a second direction, and a fifth surface and a sixth surface opposing each other in a third direction, wherein first and second recesses are formed on the third surface and the fourth surface, respectively; the coil being disposed inside the body, and including first and second withdrawal portions extending to at least one of the first or second recess; and a first external electrode disposed on the fifth surface of the body, extending to the first and second recesses, and connected to the first withdrawal portion; and a second external electrode disposed on the fifth surface of the body, extending to the first and second recesses, and connected to the second withdrawal portion.

### CROSS-REFERENCE TO RELATED APPLICATION (S)

This application claims benefit of priority to Korean Patent Application No. 10-2022-0180364 filed on Dec. 21, 2022, in the Korean Intellectual Property Office, the disclosure of which is incorporated herein by reference in its entirety.

### TECHNICAL FIELD

The present disclosure relates to a coil component.

An inductor, a type of coil component, is a representative manual electronic component used in electronic devices along with a resistor and a capacitor.

As an electronic device become higher in terms of performance and smaller, the number of electronic components used in the electronic device is increasing and becoming smaller.

External electrodes of the coil component are usually formed on two surfaces of a body opposing each other in a longitudinal direction and are connected to an internal coil. That is, as the internal coil is also withdrawn in the longitudinal direction, there may be a problem in that the degree of freedom in designing the internal coil may be limited.

### SUMMARY

An aspect of the present disclosure is to secure stability when mounting components by forming a withdrawal portion on a side surface of a coil component, and to secure a degree of freedom of coil design.

According to an aspect of the present disclosure, provided is a coil component including: a body including a core, and a first surface and a second surface opposing each other in a first direction, a third surface and a fourth surface opposing each other in a second direction, and a fifth surface and a sixth surface opposing each other in a third direction, wherein first and second recesses are formed on the third surface and the fourth surface, respectively; the coil being disposed inside the body, and including a winding portion forming at least one turn using the core as an axis, and first and second withdrawal portions extending to at least one of the first recess and the second recess; and a first external electrode disposed on the fifth surface of the body, extending to the first and second recesses, and connected to the first withdrawal portion; and a second external electrode disposed on the fifth surface of the body, extending to the first and second recesses, and connected to the second withdrawal portion.

According to example embodiments of the present disclosure, stability may be secured when mounting components, and a degree of freedom in coil design may be secured.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a view schematically illustrating a coil component according to a first example embodiment of the present disclosure;

FIG. 2 is a view illustrating a coil component according to a first example embodiment of the present disclosure when viewed from below, wherein some configurations thereof are omitted;

FIG. 3 is a view illustrating a coil component according to a first example embodiment of the present disclosure when viewed from above;

FIG. 4 is a view illustrating an exploded coil according to a first example embodiment of the present disclosure;

FIG. 5 is an enlarged view of parts A and B of FIG. 2;

FIG. 6A is a view illustrating various shapes of a first winding portion as a modified example of a coil component according to an embodiment of the present disclosure;

FIG. 6B is a view illustrating various shapes of a second winding portion as a modified example of a coil component according to an embodiment of the present disclosure;

FIG. 7 is a view illustrating a cross-section taken along line I-I′ of FIG. 1;

FIG. 8 is a view illustrating corresponding to FIG. 7 as another modified example of a coil component according to a first example embodiment of the present disclosure;

FIG. 9 is a view schematically illustrating a coil component according to a second example embodiment of the present disclosure;

FIG. 10 is a view illustrating a coil component according to a second example embodiment of the present disclosure when viewed from below, wherein some configurations thereof are omitted;

FIG. 11 is a view illustrating a coil according to a second example embodiment of the present disclosure when viewed from above;

FIG. 12 is a view illustrating an exploded coil according to a second example embodiment of the present disclosure;

FIG. 13 is an enlarged view of parts C and D of FIG. 10;

FIG. 14A is a view illustrating various shapes of a first winding portion as a modified example of a coil component according to an embodiment of the present disclosure;

FIG. 14B is a view illustrating various shapes of a second winding portion as a modified example of a coil component according to an embodiment of the present disclosure;

FIG. 15 is a view schematically illustrating a coil component according to a third example embodiment of the present disclosure; and

FIG. 16 is a view schematically illustrating a coil component according to a fourth example embodiment of the present disclosure.

### DETAILED DESCRIPTION

The term used herein is for the purpose of describing particular embodiments only and is not intended to be limiting of the present disclosure. The singular also includes the plural unless specifically stated otherwise in the phrase. It will be further understood that the terms “comprises,” “comprising,” “includes” and/or “including,” when used herein, specify the presence of stated features, integers, steps, operations, elements, components and/or combinations thereof, but do not preclude the presence or addition of one or more other features, integers, steps, operations, elements, components, and/or groups thereof. Furthermore, throughout the specification, the term “on” means positioning above or below the object portion, but does not essentially mean positioning on the upper side of the object portion based on a gravity direction.

The term “coupled to,” “combined to,” and the like, may not only indicate that elements are directly and physically in contact with each other, but also include the configuration in which the other element is interposed between the elements such that the elements are also in contact with the other component.

In the drawings, sizes and thicknesses of elements illustrated in the drawings are indicated as examples for ease of description, and example embodiments in the present disclosure are not limited thereto.

In the drawings, an X-direction may be defined as a first direction or an L direction, a Y-direction may be a second direction or a W direction, and a Z-direction may be a third direction or a T direction.

In the descriptions described with reference to the accompanied drawings, the same elements or elements corresponding to each other will be described using the same reference numerals, and overlapped descriptions will not be repeated.

In electronic devices, various types of electronic components may be used, and various types of coil components may be used between the electronic components to remove noise, or for other purposes.

In other words, in electronic devices, a coil component may be used as a power inductor, a high frequency (HF) inductor, a general bead, a GHz bead, a common mode filter, and the like.

### First Example Embodiment

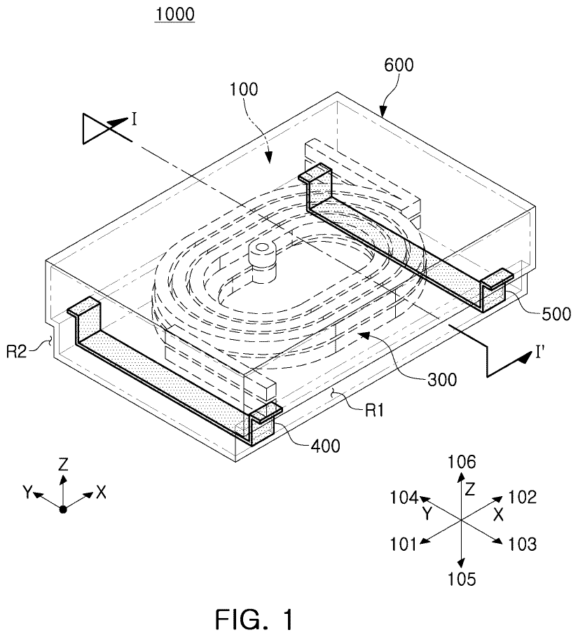

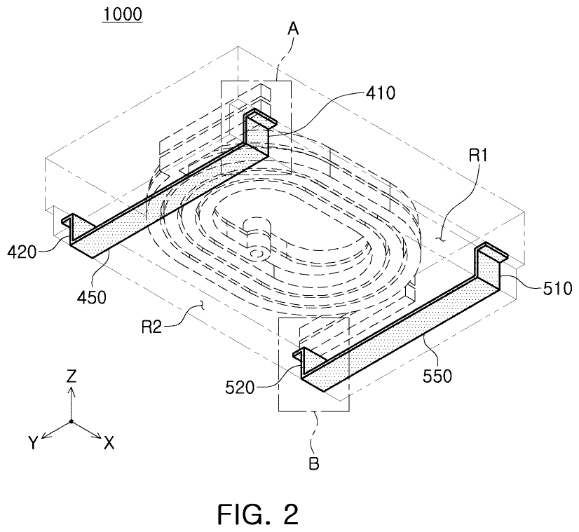

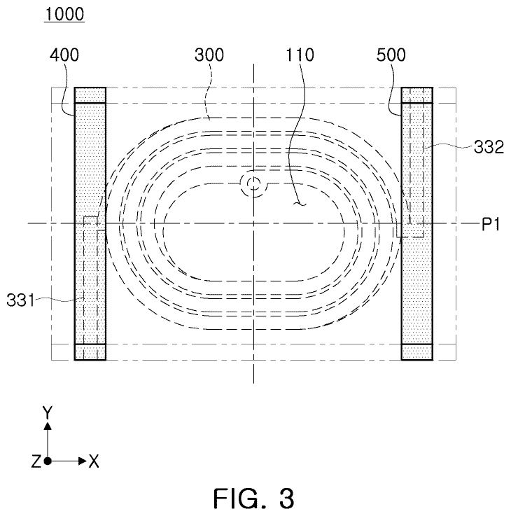

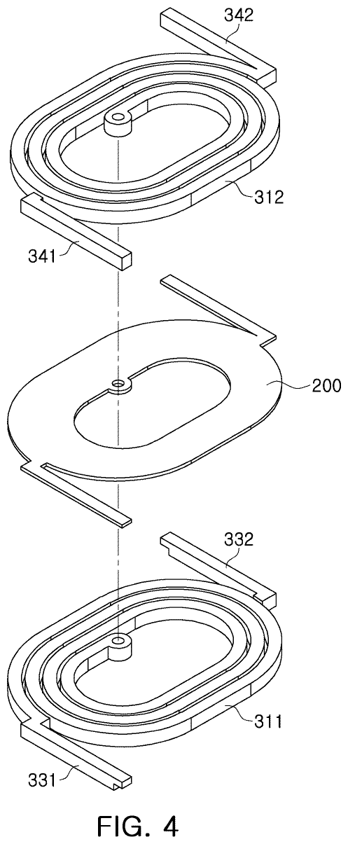

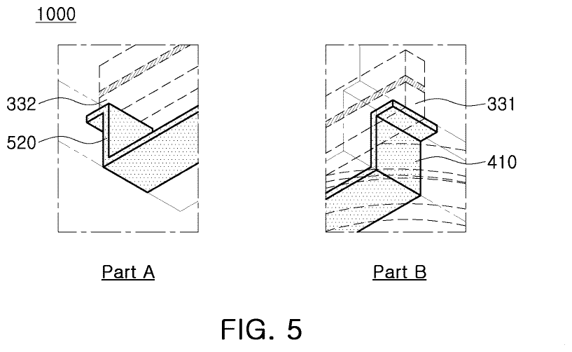

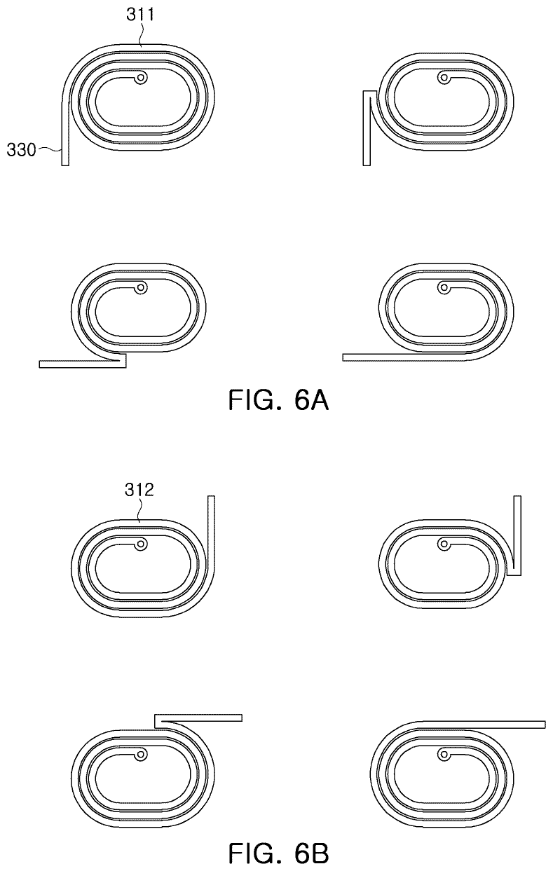

FIG. 1 is a view schematically illustrating a coil component according to a first example embodiment of the present disclosure. FIG. 2 is a view illustrating a coil component according to a first example embodiment of the present disclosure when viewed from below, wherein some configurations thereof (i.e., an insulating layer) are omitted. FIG. 3 is a view illustrating a coil component according to a first example embodiment of the present disclosure when viewed from above. FIG. 4 is a view illustrating an exploded coil according to a first example embodiment of the present disclosure. FIG. 5 is an enlarged view of parts A and B of FIG. 2. FIG. 6A is a view illustrating various shapes of a first winding portion as a modified example of a coil component according to an embodiment of the present disclosure;

FIG. 6B is a view illustrating various shapes of a second winding portion as a modified example of a coil component according to an embodiment of the present disclosure;

Referring to FIGS. 1 to 5, a coil component 1000 according to an example embodiment of the present disclosure may include a body 100, a coil 300, and external electrodes 400 and 500, and may further include a support substrate 200, a filling portion F, and an insulating layer 600.

The body 100 forms an appearance of the coil component 1000 according to this example embodiment, and the coil 300 and the support substrate 200 are disposed therein.

The body 100 may be formed in a hexahedral shape as a whole.

The body 100 includes a first surface 101 and a second surface 102 opposing each other in the X-direction (i.e., the first direction), a third surface 103 and a fourth surface 104 opposing each other in the Y-direction (i.e., the second direction), and a fifth surface 105 and a sixth surface 106 opposing each other in the Z-direction (i.e., the third direction). Each of the first to fourth surfaces 101, 102, 103 and 104 of the body 100 corresponds to wall surfaces of the body 100 connecting the fifth surface 105 to the sixth surface 106 of the body 100. Hereinafter, both end surfaces (i.e., one end surface and the other end surface) of the body 100 may refer to the first surface 101 and the second surface 102 of the body, and both side surfaces (i.e., one side surface and the other side surface) of the body 100 may refer to the third surface 103 and the fourth surface 104 of the body.

For example, the body 100 may be formed so that the coil component 1000 according to some embodiment in which the external electrodes 400 and 500, the filling portion F, and the insulating layer 600 are formed, has a length of 2.0 mm, a width of 1.2 mm, and a thickness of 0.65 mm, but the present disclosure is not limited thereto. On the other hand, since the above-described numerical values are only design values that do not reflect process errors, etc., it should be considered that the scope that can be recognized as a process error belongs to the present disclosure.

The body 100 may include a magnetic material and a resin. Specifically, the body 100 may be formed by stacking at least one magnetic composite sheet in which a magnetic material is dispersed in the resin. However, the body 100 may have a structure other than a structure in which the magnetic material is dispersed in the resin. For example, the body 100 may be made of a magnetic material such as a ferrite.

The magnetic material may include ferrite or metal magnetic powder particles.

Examples of the ferrite may include, for example, at least one of a spinel-type ferrite such as a Mg—Zn-based ferrite, a Mn—Zn-based ferrite, a Mn—Mg-based ferrite, a Cu—Zn-based ferrite, a Mg—Mn—Sr-based ferrite and a Ni—Zn-based ferrite, a hexagonal ferrite such as a Ba—Zn-based ferrite, a Ba—Mg-based ferrite, a Ba—Ni-based ferrite, a Ba—Co-based ferrite and a Ba—Ni—Co-based ferrite, a garnet-type ferrite such as a Y-based ferrite and the like, and a Li-based ferrite.

The metal magnetic powder particles may include at least one selected from the group consisting of iron (Fe), silicon (Si), chromium (Cr), cobalt (Co), molybdenum (Mo), aluminum (Al), niobium (Nb), copper (Cu), and nickel (Ni). For example, the metal magnetic powder particles may be at least one of pure iron powder particles, Fe—Si-based alloy powder particles, Fe—Si—Al-based alloy powder particles, Fe—Ni-based alloy powder particles, Fe—Ni—Mo-based alloy powder particles, Fe—Ni—Mo—Cu-based alloy powder particles, Fe—Co-based alloy powder particles, Fe—Ni—Co-based alloy powder, Fe—Cr-based alloy powder particles, Fe—Cr—Si-based alloy powder particles, Fe—Si—Cu—Nb-based alloy powder particles, Fe—Ni—Cr-based alloy powder particles, Fe—Cr—Al-based alloy powder particles.

The metal magnetic powder may be amorphous or crystalline. For example, the metal magnetic powder particles may be a Fe—Si—B—Cr-based amorphous alloy powder particles, but the present disclosure is not limited thereto.

Each of the ferrite and the metal magnetic powder particles may have an average diameter of about 0.1 μm to about 30 μm, but the present disclosure is not limited thereto.

The body 100 may include two or more types of magnetic materials dispersed in the resin. Here, the fact that magnetic materials are of different types denotes that magnetic materials in dispersed the resin are distinguishable from each other by at least one of average diameter, a composition, crystallinity, and/or a shape.

The resin may include epoxy, polyimide, a liquid crystal polymer, alone or in combination, but the present disclosure is not limited thereto.

The body 100 includes a core 110 penetrating through the coil 300 and the support substrate 200 described below. The core 110 may be formed by charging a through hole in which a magnetic composite sheet penetrates through the center of each of the coil 300 and the support substrate 200, but the present disclosure is not limited thereto.

First and second recesses R1 and R2 are formed on the third surface 103 and the fourth surface 104 of the body 100, respectively. Specifically, the first recess R1 may be disposed at a corner between the third surface 103 of the body 100 and the fifth surface 105 of the body 100, and the second recess R2 may be disposed at a corner between the fourth surface 104 of the body 100 and the fifth surface 105 of the body 100. Meanwhile, the first and second recesses R1 and R2 may be formed to have a depth h1 (e.g., a length of the first and second recesses in the Z-direction) at which first and second withdrawal portions 331 and 332, respectively, described below are exposed to internal surfaces of the first and second recesses R1 and R2, but the first and second recesses R1 and R2 do not extend to the sixth surface 106 of the body 100. That is, the first and second recesses R1 and R2 do not penetrate through the body 100 in the Z-direction. In other words, the first and second recesses R1 and R2 need to expose the withdrawal portion 331 and 332 to the internal surfaces for a connection between the withdrawal portions 331 and 332 and the external electrodes 400 and 500 described below, and accordingly, the depth h1 of the first and second recesses R1 and R2 may be greater than or equal to a distance from at least one surface of the body 100 to the withdrawal portions 331 and 332.

The first and second recesses R1 and R2 may extend to the first and second surfaces 101 and 102 of the body 100 in the X-direction (i.e., the first direction) of the body (100), respectively. That is, the first and second recesses R1 and R2 may be in the form of a slit formed in the entire X-direction (i.e., the first direction) of the body 100. On a coil bar level before individualizing each coil component, the first and second recesses R1 and R2 may be formed by performing pre-dicing on one side of a coil bar along a boundary line that matches the X-direction (i.e., the first direction) of each coil components among boundary lines for individualizing each coil component. The depth during the pre-dicing is adjusted to expose the withdrawal portions 331 and 332.

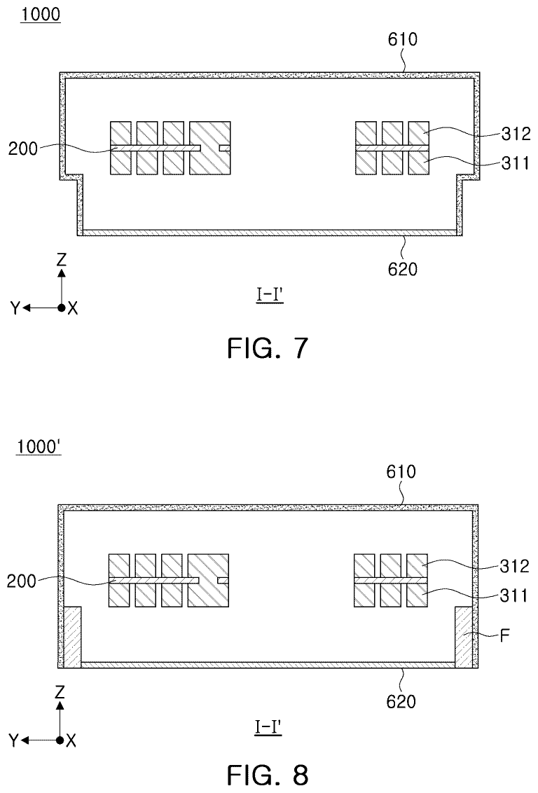

On the other hand, the internal surfaces of the first and second recesses R1 and R2 also form a surface of the body 100, but for convenience of explanation, the internal surfaces of the first and second recesses R1 and R2 are distinguished from the surface of the body 100. In FIG. 7, the first and second recesses R1 and R2 are illustrated as having internal walls, parallel to the third and fourth surfaces 103 and 104 of the body 100, and a bottom surface, parallel to the fifth and sixth surfaces 105 and 106 of the body 100, but this is for convenience of explanation, and the scope of this example embodiment is not limited thereto. Hereinafter, for convenience of description, it will be described that the first and second recesses R1 and R2 have an internal wall and a bottom surface.

The support substrate 200 is buried in the body 100. The support substrate 200 is configured to support a coil 300 described below.

The support substrate 200 may include an insulating material including a thermosetting insulating resin such as an epoxy resin, a thermoplastic insulating resin such as polyimide, or a photosensitive insulating resin, and the support substrate 200 may include an insulating material in which a reinforcing material such as a glass fiber or an inorganic filler is impregnated in the insulating resin. For example, the support substrate 200 may include an insulating material such as prepreg, an Ajinomoto Build-up Film (ABF), FR-4, a Bismaleimide Triazine (BT) resin, and photoimageable dielectric (PID), but the present disclosure is not limited thereto.

The inorganic filler may include at least one selected from the group consisting of silica (SiO₂), alumina (Al₂O₃), silicon carbide (SiC), barium sulfate (BaSO₄), talc, mud, mica powder particles, aluminum hydroxide (Al(OH)₃), and magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), calcium zirconate (CaZro₃), or combinations thereof.

When the support substrate 200 includes the insulating material including a reinforcing material, the support substrate 200 may provide more excellent rigidity. When the support substrate 200 includes an insulating material that does not include glass fibers, the support substrate 200 may be advantageous in thinning a thickness of the coil component 1000 according to an example embodiment of the present disclosure. Furthermore, based on the body 100 having the same size, the volume occupied by the coil 300 and/or magnetic material may be increased, thereby improving component characteristics. When the support substrate 200 is formed of an insulating material including a photosensitive insulating resin, the number of processes for forming the coil 300 may be reduced, which may be advantageous in reducing production costs and may form fine vias.

The coil 300 is disposed inside the body 100 to express the characteristics of the coil component. For example, when the coil component 1000 of this example embodiment is used as a power inductor, the coil 300 may stabilize the power of the electronic device by storing an electrical field as a magnetic field and maintaining an output voltage.

The coil 300 includes a winding portion 311 and a withdrawal portion 330. The winding portion 311 forms at least one turn using the core 110 as an axis. The withdrawal portion 330 is formed at both ends of the winding portion 311 and is connected to external electrodes 400 and 500 described below.

The withdrawal portion 330 may be disposed to be biased to one of the third surface 103 and the fourth surface 104 of the body. Here, ‘being biased’ means that it can be disposed of close to one surface of the body. Referring to FIG. 3, the first and second withdrawal portion 331, 332 are disposed to be biased to the third surface 103 and the fourth surface 104 of the body, respectively.

The withdrawal portion 330 may not form a turn using the core 110 as an axis. Accordingly, the withdrawal portion 330 may have no curvature or substantially no curvature.

As the withdrawal portion 330 is biased to one of the third surface 130 or the fourth surface 104 of the body, the withdrawal portion 330 may extend in a straight line shape and may be connected to the winding portion 311. Specifically, the withdrawal portion 330 may be connected to the winding portion in the first direction of the body, or may be connected to the winding portion in the second direction of the body. When the withdrawal portion 330 extends in the first direction, the withdrawal portion 330 may be substantially parallel to the first surface 101 of the body and may extend by a surface passing through the center of the core 110. When the withdrawal portion extends in the second direction, the withdrawal portion 330 may be substantially parallel to the third surface 103 of the body and may extend by the surface passing through the center of the core 110.

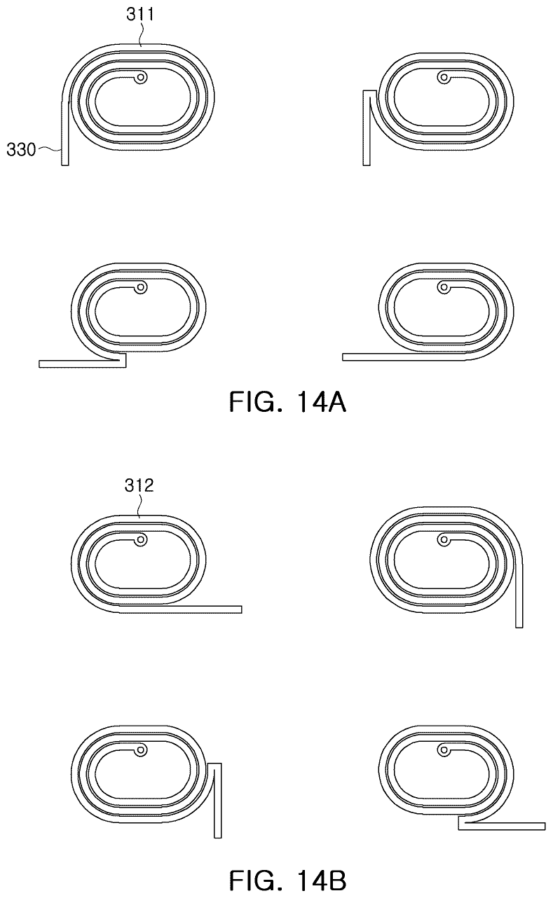

Referring to FIG. 3, the withdrawal portion 330 is connected to the coil 300 in the second direction of the body. Furthermore, FIG. 3 illustrates a surface P1 which is parallel to the third surface 103 and the fourth surface 104 and passing through the core, from which it may be seen that the withdrawal portion of the coil is extended by the surface P1. FIGS. 6 and 14 are views illustrating a coil according to example embodiments of the present disclosure, from which a direction in which the withdrawal portion 330 extends and a length thereof may be confirmed.

The coil 300 may be disposed on the support substrate 200, and a structure thereof will be described in detail below. When the coil 300 is disposed on the support substrate 200, the coil component may include an auxiliary withdrawal portion.

Specifically, based on the directions of FIGS. 1, 2, 4, and 7, a first winding portion 311, a first withdrawal portion 331, and a second withdrawal portion 332 may be disposed on a lower surface of the support substrate 200, and a second winding portion 312, a first auxiliary withdrawal portion 341, and a second auxiliary withdrawal portion 342 may be disposed on an upper surface of the support substrate 200 opposing the lower surface of the support substrate 200. That is, as the second winding portion 312 is disposed on the upper surface of the support substrate 200, the second auxiliary withdrawal portion 342 may be disposed on the upper surface of the support substrate 200.

On the lower surface of the support substrate 200, the first winding portion 311 is in contact with the first withdrawal portion 331 and is spaced apart from the second withdrawal portion 332. On the upper surface of the support substrate 200, the second winding portion 312 is in contact with the second auxiliary withdrawal portion 342 and is spaced apart from the first auxiliary withdrawal portion 341. A first via penetrates through the support substrate 200 and is in contact with and connected to the first winding portion 311 and the second winding portion 312, respectively. A second via penetrates through the support substrate 200 and is in contact with and connected to the first withdrawal portion 331 and the first auxiliary withdrawal portion 341, respectively. A third via penetrates through the support substrate 200 and is in contact with and connected to the second withdrawal portion 332 and the second auxiliary withdrawal portion 342, respectively. In this manner, the coil 300 may function as a single coil as a whole.

The first auxiliary withdrawal portion 341 may be omitted. That is, since the first winding portion 311 is connected to the first withdrawal portion 331 on the lower surface of the support substrate 200, the first auxiliary withdrawal portion 341 formed on the upper surface of the support substrate 200 may be omitted.

In some embodiments, at least a portion of the first withdrawal portion 331 and the second withdrawal portion 332 extends to the first and second recesses R1 and R2, respectively. Specifically, at least a portion of the first withdrawal portion 331 extends to an internal surface of the first recess R1, and at least a portion of the second withdrawal portion 332 extends to an internal surface of the second recess R2. Since the connection portion 410 of the first external electrode 400 and the connection portion 510 of the second external electrode 500 described below are disposed on the first recess R1, and the connection portion 420 of the first external electrode 400 and the connection portion 520 of the second external electrode 500 are disposed on the second recess R2, the coil 300 and the external electrodes 400 and 500 are in contact with and connected to each other.

On the other hand, hereinafter, for convenience of explanation, as described in FIGS. 1 and 2, example embodiments of the present disclosure are described on the premise that the first and second recesses R1 and R2 extend to an interior of at least a portion of each of the first and second withdrawal portions 331 and 332, and the first and second withdrawal portions 331 and 332 extend to internal walls and bottom surfaces of the first and second recesses R1 and R2, respectively, but this is only an example, and the scope of this example embodiment is not limited thereto. That is, a depth h1 of the first and second recesses R1 and R2 may be adjusted so that the withdrawal portions 331 and 332 extend only to the bottom surfaces of the first and second recesses R1 and R2. On the other hand, when the first and second withdrawal portions 331 and 332 extend to both the bottom surfaces and the internal walls of the first and second recesses R1 and R2, respectively, a contact area between the withdrawal portions 331 and 332 and the connection portions 410 and 520 of the external electrodes 400 and 500 may increase, respectively, thereby increasing coupling force between the coil 300 and the external electrodes 400 and 500.

One surface of the withdrawal portions 331 and 332 extending to the internal surfaces of the first and second recesses R1 and R2, respectively, may have a higher surface roughness than that of the other surface of the first and second withdrawal portions 331 and 332. For example, when the first and second withdrawal portions 331 and 332 are formed by electrolytic plating and then the first and second recesses R1 and R2 are formed on the first and second withdrawal portions 331 and 332 and the body 100, a portion of the first and second withdrawal portions 331 and 332 is removed from a recess formation process. For this reason, one surface of the first and second withdrawal portions 331 and 332 extending to the internal walls and the bottom surfaces of the first and second recesses R1 and R2 has a higher surface roughness than that of the other surface of the withdrawal portions 331 and 332 due to the polishing of a dicing tip. As will be described below, the first and second external electrodes 400 and 500 may be formed of a thin film and thus has weak coupling force with the body 100, but the first and second external electrodes 400 and 500 may be in contact with and connected to one surface of the first and second withdrawal portions 331 and 332 having relatively high surface roughness, thereby improving coupling force between the first and second external electrodes 400 and 500 and the first and second withdrawal portions 331 and 332.

In some embodiments, the withdrawal portions 331 and 332 and the auxiliary withdrawal portions 341 and 342 extend to the third surface 103 and the fourth surface 104 of the body 100, respectively. That is, the first withdrawal portion 331 extends to the third surface 103 of the body 100, and the second withdrawal portion 332 extends to the fourth surface 104 of the body 100. The first auxiliary withdrawal portion 341 may be omitted, but when the first auxiliary withdrawal portion 341 is formed, it extends to the third surface 103 of the body 100. The second auxiliary withdrawal portion 342 extends to the fourth surface 104 of the body 100. For this reason, the first withdrawal portion 331 extends continuously to the internal wall of the first recess R1, the bottom surface of the first recess R1, and the third surface 103 of the body 100, and the second withdrawal portion 332 extends continuously to the internal wall of the second recess R2, the bottom surface of the second recess R2, and the fourth surface 104 of the body 100.

At least one of the winding portions 311 and 312, the via, and the withdrawal portions 331, 332, 341 and 342 may include at least one conductive layer.

For example, when the second winding portion 312, the first and second auxiliary withdrawal portions 341 and 342, and the via are formed by plating on the upper surface of the support substrate 200, each of the second winding portion 312, the first and second auxiliary withdrawal portions 341 and 342, and the via may include a seed layer and an electrolytic plating layer. That is, the coil component 1000 according to the present embodiment may be a thin film coil component, and the coil 300 may be formed in a coil-shaped pattern formed on both surfaces of the support substrate 200, respectively. Here, the electroplating layer may have a single layer structure or a multilayer structure. The multilayer electroplating layer may be formed in a conformal film structure in which another electroplating layer is formed along a surface of one electroplating layer, or may be formed in a shape in which another electroplating layer is stacked only on one surface of one electroplating layer. The seed layer may be formed by an electroless plating method or a vapor deposition method such as sputtering. The seed layer of the second winding portion 312, the seed layer of the auxiliary withdrawal portions 341 and 342, and the seed layer of the via are integrally formed so that no boundary may be formed between the seed layers, but the present disclosure is not limited thereto. The electroplating layer of the second winding portion 312, the electroplating layer of the auxiliary withdrawal portions 341 and 342, and the electroplating layer of the via may be integrally formed so that no boundary between the electroplating layers may be formed, but the present disclosure is not limited thereto.

In some embodiments, when the first winding portion 311 and the first and second withdrawal portions 331 and 332 disposed on a lower side of the support substrate 200, and the second winding portion 312 and the first and second auxiliary withdrawal portions 341 and 342 disposed on an upper side of the support substrate 200 are formed separately from each other and then collectively stacked on the support substrate 200 to form the coil 300, the via may include a high melting point metal layer and a low melting point metal layer having a melting point lower than that of the high melting point metal layer. Here, the low melting point metal layer may include a solder including lead (Pb) and/or tin (Sn). At least a portion of the low melting point metal layer may be melted due to pressure and a temperature during collective stacking, and for example, an intermetallic compound layer (IMC layer) may be formed at a boundary between the low melting point metal layer and the second winding portion 312.

The first and second winding portions 311 and 312, the first and second withdrawal portions 331 and 332, and the first and second auxiliary withdrawal portions 341 and 342 may protrude from, for example, the lower surface and the upper surface of the support substrate 200, respectively. As another example, the first winding portion 311 and the first and second withdrawal portions 331 and 332 protrude from the lower surface of the support substrate 200, and the second winding portion 312 and the first and second auxiliary withdrawal portions 341 and 342 are buried in the upper surface of the support substrate 200, so that upper surfaces thereof may be exposed to the upper surface of the support substrate 200. In this case, since a concave portion is formed on an upper surface of the second winding portion 312 and/or an upper surface of the second winding portions 341 and 342, the upper surface of the support substrate 200 and the upper surface of the second winding portion 312 and/or the upper surface of the auxiliary withdrawal portions 341 and 342 may not be disposed on the same plane.

Each of the winding portions 311 and 312, the via, the withdrawal portions 331 and 332, and the auxiliary withdrawal portions 341 and 342 may include a conductive material such as copper (Cu), aluminum (Al), silver (Ag), tin (Sn), gold (Au), nickel (Ni), lead (Pb), titanium (Ti), chromium (Cr), or alloys thereof, but the present disclosure is not limited thereto.

FIG. 6A is a view illustrating various shapes of a first winding portion as a modified example of a coil component according to an embodiment of the present disclosure;

FIG. 6B is a view illustrating various shapes of a second winding portion as a modified example of a coil component according to an embodiment of the present disclosure; Specifically, various examples of a winding portion 311 and a withdrawal portion 330 that may be formed in the coil component according to the first example embodiment are illustrated. That is, in the case of a coil component according to some embodiments of the present disclosure, as described below, the withdrawal portion 330 of the coil may be connected to connection portions 410, 420, 510 and 520 of any external electrode, thus securing design freedom when designing the coil. Referring to FIG. 6A, the withdrawal portion 330 may extend in the first direction (or the second direction) of the body, and in this case, the withdrawal portion 330 may be parallel to the first surface (or the third surface) of the body and may extend to a surface passing through the center of the core 110.

The first and second external electrodes 400 and 500 are disposed on the fifth surface 105 of the body and spaced apart from each other, and each of the first and second external electrodes 400 and 500 extends to the first and second recesses R1 and R2 to come into contact with the first and second withdrawal portions 331 and 332. In other words, the first external electrode 400 is disposed on the fifth surface 105 of the body, extends to the first and second recesses R1 and R2 and is connected to the first withdrawal portion 331, and the second external electrode 500 is disposed on the fifth surface 105 of the body, and extends to the first and second recesses R1 and R2 and is connected to the second withdrawal portion 332. The first and second external electrodes 400 and 500 are spaced apart from each other in the first direction (X-direction) of the body 100.

Specifically, the first external electrode 400 includes an extension portion 450 disposed on the fifth side 105 of the body 100 and connection portions 410 and 420 connected to the extension portion 450, disposed on the internal surfaces of the first and second recesses R1 and R2 and connected to the coil. The connection portion of the first external electrode 400 includes a first recess connection portion 410 disposed on the internal surface of the first recess and a second recess connection portion 420 disposed on the internal surface of the second recess.

Referring to FIG. 5A, in some embodiments of the present disclosure, since at least a portion of the first withdrawal portion 331 and the second withdrawal portion 332 extends to the first and second recesses R1 and R2, the connection portion at the first recess R1 in which at least a portion of the first withdrawal portion 331 extends, that is, the first recess connection portion 410 of the first external electrode, is connected to the first withdrawal portion 331. The second recess connection portion 420 of the first external electrode may not be connected to the coil 300, but the present disclosure is not limited thereto.

Similarly, the second external electrode 500 includes an extension portion 550 disposed on the fifth surface 105 of the body 100 and connection portions 510 and 520 connected to the extension portion 550, disposed on the internal surfaces of the first and second recesses R1 and R2 and connected to the coil. A connection portion of the second external electrode 500 includes a first recess connection portion 510 disposed on the internal surface of the first recess R1 and a second recess connection portion 520 disposed on the internal surface of the second recess.

Referring to FIG. 5B, in some embodiments of the present disclosure, since at least a portion of the first withdrawal portion 331 and the second withdrawal portion 332 extends to the first and second recesses R1, R2, respectively, a connection portion at the second recess R2 in which at least a portion of the second withdrawal portion 332 extends, that is, the second recess connection portion 520 of the second external electrode 500, is connected to the second withdrawal portion 332. The first recess connection portion 510 of the second external electrode 500 may not be connected to the coil 300, but the present disclosure is not limited thereto.

In this manner, in some embodiments of the present disclosure, the first external electrode 400 may include connection portions 410 and 420 disposed on the internal surfaces of the first and second recesses R1 and R2, the second external electrode 500 may include connection portions 510 and 520 disposed on the internal surfaces of the first and second recesses R1 and R2, and each of the connections 410, 420, 510 and 520 may be connected to the coil 300. Furthermore, the connection portions 410, 420, 510 and 520 may be connected to the withdrawal portion of the coil exposed to a side surface of the body 100, and accordingly, when the coil component 1000 is mounted and used, left and right shifts of products may be prevented to secure mounting stability.

The extension portions 450 and 550 and the connection portions 410, 420, 510, and 520 are formed integrally with each other along the internal surfaces of the first and second recesses R1 and R2 and the fifth surface 105 of the body 100. Specifically, in the case of the first external electrode 400, the extension portion 450 and the connection portions 410 and 420 are formed integrally with each other along the internal surfaces of the first and second recesses R1 and R2 and the fifth surface 105 of the body 100, and are formed continuously. In the case of the second external electrode 500, the extension portion 550 and the connection portions 510 and 520 are formed integrally with each other along the internal surfaces of the first and second recesses R1 and R2 and the fifth surface 105 of the body 100, and are formed continuously. That is, the external electrodes 400 and 500 are formed in the form of a conformal film on the internal surfaces of the first and second recesses R1 and R2 and the fifth surface 105 of the body 100. The connection portions 410, 420, 510 and 520 and the extension portions 450 and 550 of the external electrodes 400 and 500 may be formed together in the same process and may be integrally formed on the internal surfaces of the first and second recesses R1 and R2 and the fifth surface 105 of the body 100. That is, mutual boundaries may not be formed between the connection portions 410, 420, 510 and 520 and the extension portions 450 and 550.

The external electrodes 400 and 500 may be formed by a vapor deposition method such as sputtering and/or a plating method, but the present disclosure is not limited thereto.

The external electrodes 400 and 500 may be formed of a conductive material such as copper (Cu), aluminum (Al), silver (Ag), tin (Sn), gold (Au), nickel (Ni), lead (Pb), chromium (Cr), titanium (Ti), or alloys thereof, but the present disclosure is not limited thereto. The external electrodes 400 and 500 may be formed in a single layer or a plurality of layers. For example, the external electrodes 400 and 500 are sequentially plated and formed on the extension portions 450 and 550 including copper (Cu), and may include first and second layers including nickel (Ni) and tin (Sn), respectively, but the present disclosure is not limited thereto.

The connection portions 410, 420, 510 and 520 may be disposed on the side surface of the body 100 such that they are spaced apart from each of the first surface 101 and the second surface 102 of the body 100.

The extension portions 450 and 550 may be disposed on the fifth surface 105 of the body 100 such that they are spaced apart from each of the first surface 101 and the second surface 102 of the body 100. In this case, the coil component 1000 according to this example embodiment may be prevented from being short-circuited with other components mounted outside a mounting substrate in the X-direction (i.e., the first direction).

An insulating film IF is disposed between the coil 300 and the body 100, and between the support substrate 200 and the body 100. The insulating film IF may be formed along the surfaces of the withdrawal portions 331 and 332, the winding portions 311 and 312, the support substrate 200, and the auxiliary withdrawal portions 341 and 342, but the present disclosure is not limited thereto. The insulating film IF is meant to insulate the coil 300 from the body 100, and may include a known insulating material such as a parylene, but the present disclosure is not limited thereto. As another example, the insulating layer IF may include an insulating material such as an epoxy resin, not parylene. The insulating layer IF may be formed by a vapor deposition method, but the present disclosure is not limited thereto. As another example, the insulation film IF may be formed by stacking and curing an insulation film for forming the insulation film IF on both surfaces of the support substrate 200 in which the coil 300 is formed, or may be formed by applying and curing an insulation paste for forming the insulation film IF on both surfaces of the support substrate 200 in which the coil 300 is formed. Meanwhile, for the above-described reasons, the insulating film IF s a configuration that can be omitted in this example embodiment. That is, when the body 100 has sufficient electrical resistance at a designed operating current and voltage of the coil component 1000 according to this example embodiment, the insulating film IF can be omitted in the present embodiment.

FIG. 7 is a view illustrating a cross-section taken along line I-I′ of FIG. 1.

The coil component 1000 according to an example embodiment of the present disclosure may further include a first insulating layer 610. The first insulating layer 610 is disposed on first to fourth surfaces 101, 102, 103 and 104 and a sixth surface 106 of a body 100, and the first insulating layer 610 is disposed on first and second external electrodes 400 and 500. Specifically, the first insulating layer 610 is formed along internal walls and bottom surfaces of first and second recesses R1 and R2 to cover connection portions 410, 420, 510 and 520 of each of the first and second external electrodes 400 and 500, but exposes extension portions 450 and 550 of each of the first and second external electrodes 400 and 500. The first insulating layer 610 may be formed by applying a liquid insulating resin to the body 100, stacking an insulating film such as a dry film DF on the body 100, or forming an insulating material on a surface of the body 100 and the connection portions 410, 420, 510 and 520 by vapor deposition. An Ajinomoto Build-up film (ABF) or a polyimide film that does not include a photosensitive insulating resin may be used in the case of an insulating film.

Furthermore, in the case of the coil component 1000 according to an example embodiment of the present disclosure, a second insulating layer 620 may be further included. The second insulating layer 620 may be disposed on the fifth surface 105 of the body 100 and may expose the extension portions 450 and 550 of the first and second external electrodes 400 and 500. Meanwhile, in the case of an example embodiment of the present disclosure, a second insulating layer 620 may be formed on the fifth surface 105 of the body 100 before the external electrodes 400 and 500 are formed. Accordingly, the second insulating layer 620 may function as a mask in selectively forming the external electrodes 400 and 500 on the fifth surface 105 of the body 100 and the internal surfaces of the first and second recesses R1 and R2. For example, the second insulating layer 620 may function as a plating resist when forming the external electrodes 400 and 500 by a plating method.

Each of the insulating layers 610 and 620 may include a thermoplastic resin such as a polystyrene-based resin, a vinyl acetate-based resin, a polyester-based resin, a polyethylene-based resin, a polypropylene-based resin, a polyamide-based resin, a rubber-based resin, an acrylic-based resin, a thermosetting resin such as a phenol-based resin, an epoxy-based resin, a urethane-based resin, a melamine-based resin and an alkyd-based resin, a photosensitive resin, parylene, Siox or SiNx. Each of the insulating layers 610 and 620 may further include an insulating filler such as an inorganic filler, but the present disclosure is not limited thereto.

### Modified Example of First Example Embodiment

FIG. 8 is a view corresponding to FIG. 7 as another modified example of a coil component according to a first example embodiment of the present disclosure.

Referring to FIG. 8, a coil component 1000′ according to a modified example of a first example embodiment of the present disclosure further includes a filling portion F when compared to the coil portion 1000 according to the first example embodiment of the present disclosure.

Accordingly, in describing the modified example of the present disclosure, only the filling portion F as a different element from the first example embodiment and a first insulating layer 610 covering the filling portion F will be described. The description in the first example embodiment of the present disclosure may be applied to the remaining configurations of this example embodiment of the present disclosure.

Referring to FIG. 8, the filling portion F fills at least a portion of first and second recesses R1 and R2 and covers connection portions 410, 420, 510 and 520 of first and second external electrodes 400 and 500.

One surface of the filling portion F may be disposed on substantially the same plane as each of the first to fourth surfaces 101, 102, 103 and 104, which are a plurality of wall surfaces of the body 100. For example, by filling a space between adjacent bodies in a coil bar state with a material for forming the filling portion and then performing a full dicing treatment, one surface of the filling portion F may be disposed on substantially the same plane as each of the first to fourth surfaces 101, 102, 103 and 104 of the body 100.

The filling portion F may include an insulating resin. The insulating resin may include epoxy, polyimide, and a liquid crystal polymer alone or in combination, but the present disclosure is not limited thereto. The filling portion F may further include magnetic powder particles dispersed in an insulating resin. The magnetic powder particles may be ferrite or metal magnetic powder particles. Examples of the ferrite powder particles may include, for example, at least one of a spinel-type ferrite such as a Mg—Zn-based ferrite, a Mn—Zn-based ferrite, a Mn—Mg-based ferrite, a Cu—Zn-based ferrite, a Mg—Mn—Sr-based ferrite and a Ni—Zn-based ferrite, a hexagonal ferrite such as a Ba—Zn-based ferrite, a Ba—Mg-based ferrite, a Ba—Ni-based ferrite, a Ba—Co-based ferrite and a Ba—Ni—Co-based ferrite, a garnet-type ferrite such as a Y-based ferrite and the like, and a Li-based ferrite. The metal magnetic powder particles may include at least one selected from the group consisting of iron (Fe), silicon (Si), chromium (Cr), cobalt (Co), molybdenum (Mo), aluminum (Al), niobium (Nb), copper (Cu), and nickel (Ni). For example, the metal magnetic powder particles may be at least one of pure iron powder particles, Fe—Si-based alloy powder particles, Fe—Si—Al-based alloy powder particles, Fe—Ni-based alloy powder particles, Fe—Ni—Mo-based alloy powder particles, Fe—Ni—Mo—Cu-based alloy powder particles, Fe—Co-based alloy powder particles, Fe—Ni—Co-based alloy powder, Fe—Cr-based alloy powder particles, Fe—Cr—Si-based alloy powder particles, Fe—Si—Cu—Nb-based alloy powder particles, Fe—Ni—Cr-based alloy powder particles, Fe—Cr—Al-based alloy powder particles. The metal magnetic powder particles may be amorphous or crystalline. For example, the metal magnetic powder particles may be a Fe—Si—B—Cr-based amorphous alloy powder particles, but the present disclosure is not limited thereto. Each of the ferrite and the metal magnetic powder particles may have an average diameter of about 0.1 μm to 30 μm, but the present disclosure is not limited thereto.

A first insulating layer 610 may be disposed on the first to fourth surfaces 101, 102, 103 and 104 and the sixth surface 106 of the body 100, and may be disposed on the filling portion F. That is, as compared to the coil component 1000 according to the first example embodiment, since at least a portion of the first and second recesses R1 and R2 is filled by the filling portion, a portion of the first insulating layer 610 is disposed on the filling portion F.

Descriptions of the coil component except for the aforementioned contents overlap with those of the first example embodiment, and will be omitted below.

### Second Example Embodiment

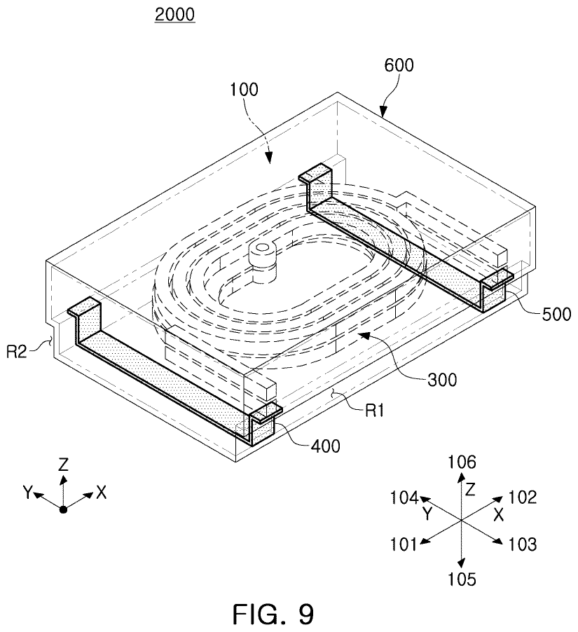

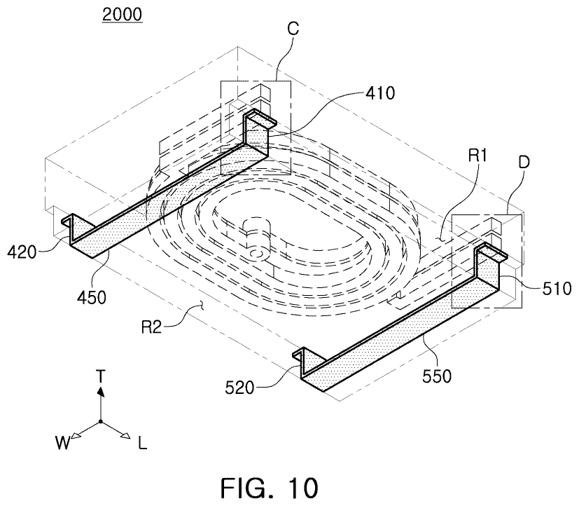

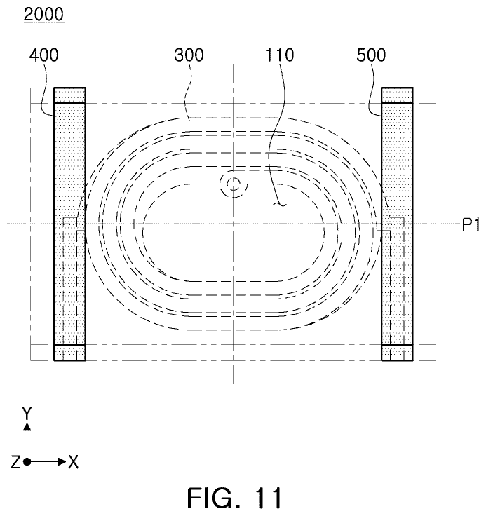

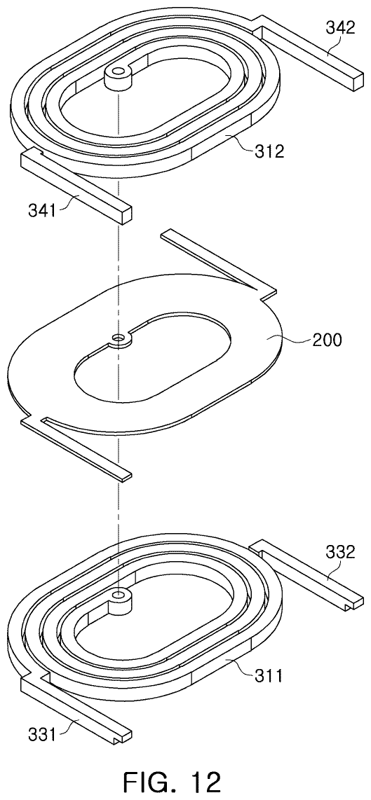

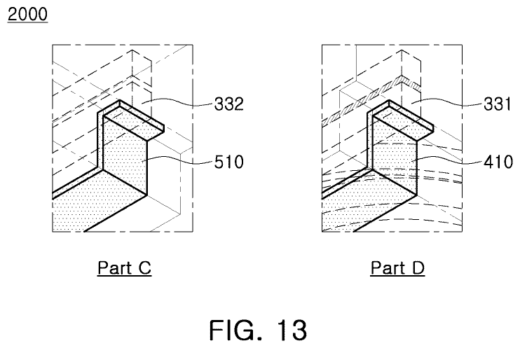

FIG. 9 is a view schematically illustrating a coil component according to a second example embodiment of the present disclosure. FIG. 10 is a view illustrating a coil component according to a second example embodiment of the present disclosure when viewed from bottom, wherein some configurations thereof are omitted. FIG. 11 is a view illustrating a coil according to a second example embodiment of the present disclosure when viewed from above. FIG. 12 is a view illustrating an exploded coil according to a second example embodiment of the present disclosure. FIG. 13 is an enlarged view of parts C and D of FIG. 9. FIG. 14A is a view illustrating various shapes of a first winding portion as a modified example of a coil component according to an embodiment of the present disclosure;

FIG. 14B is a view illustrating various shapes of a second winding portion as a modified example of a coil component according to an embodiment of the present disclosure.

Referring to FIGS. 9 to 13, a coil component 2000 according to a second example embodiment of the present disclosure differs from the coil component 1000 according to the first example embodiment of the present disclosure in terms of a body 100 in which coil withdrawal portions 331 and 332 extend. Specifically, the withdrawal portions 331 and 332 and auxiliary withdrawal portions 341 and 342 of the coil component 2000 according to the second example embodiment extend to a third surface 103 of the body 100. For this reason, the first and second withdrawal portions 331 and 332 extend continuously to an internal wall of a first recess R1, a bottom surface of the first recess R1, and the third surface 103 of the body 100.

That is, in the coil component 1000 according to the first example embodiment, at least a portion of the first withdrawal portion 331 and the second withdrawal portion 332 extends to the first and second recesses R1 and R2, respectively, whereas in the coil component 2000 according to the second example embodiment, at least a portion of the first withdrawal portion 331 and the second withdrawal portion 332 extends to the first recess R1. Since the connection portions 410 and 510 of the external electrodes 400 and 500 are arranged in the first recess R1, the coil 300 and the external electrodes 400 and 500 are in contact with and connected to each other.

Referring to part C of FIG. 13, according to the second example embodiment of the coil component 2000, since at least a portion of the first withdrawal portion 331 and the second withdrawal portion 332 extend to the first recess R1, a connection portion at the first recess R1 in which at least a portion of the first withdrawal portion 331 extends, which is a first recess connection portion 410 of the first external electrode, is connected to the first withdrawal portion 331. The second recess connection portion 420 of the first external electrode may not be connected to the coil 300, but the present disclosure is not limited thereto.

Referring to part D of FIG. 13, according to the second example embodiment of the coil component 2000, since at least a portion of the first withdrawal portion 331 and the second withdrawal portion 332 extend to the first recess R1, a connection portion at the first recess R1 in which at least a portion of the second withdrawal portion 332 extends, which is a first recess connection portion 510 of the second external electrode, is connected to the second withdrawal portion 332. The second recess connection portion 520 of the second external electrode may not be connected to the coil 300, but the present disclosure is not limited thereto.

FIG. 14A is a view illustrating various shapes of a first winding portion as a modified example of a coil component according to an embodiment of the present disclosure;

FIG. 14B is a view illustrating various shapes of a second winding portion as a modified example of a coil component according to an embodiment of the present disclosure. Specifically, various examples of a winding portion 311 and a withdrawal portion 330 that may be formed in the coil component according to the second example embodiment are illustrated. As described above in FIG. 6A, the withdrawal portion 330 of the coil 300 may extend in the first direction (or the second direction) of the body, and in this case, the withdrawal portion 330 may be substantially parallel to the first surface (or the third surface) of the body and may extend to any surface passing through the center of the core 110. However, as compared to FIG. 6A, in the coil component 2000 according to the second example embodiment, the second withdrawal portion 332 extends to the first recess R1, and accordingly, the coil component 2000 according to the second example embodiment is different from the example embodiment illustrated in FIG. 6A, in a position in which the second withdrawal portion 332 is disposed.

The descriptions in the first example embodiment of the present disclosure may be applied to the remaining components of this example embodiment, and the detailed description is redundant and will be omitted below.

### Third Example Embodiment

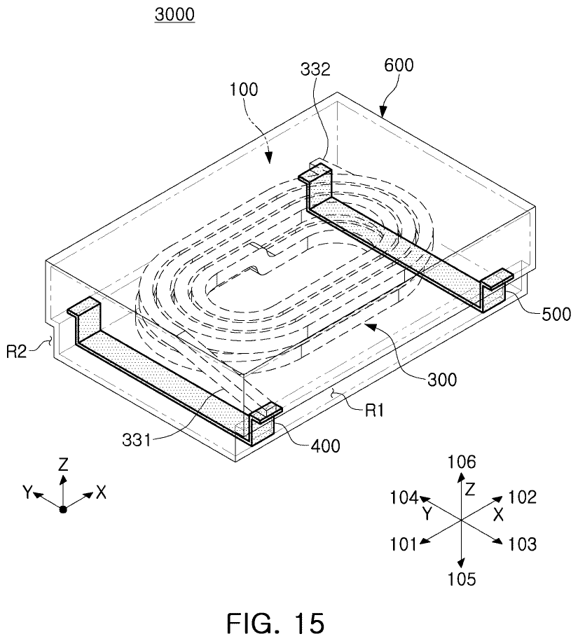

FIG. 15 is a view schematically illustrating a coil component according to a third example embodiment of the present disclosure.

Referring to FIG. 15, a coil component 3000 according to a third example embodiment of the present disclosure has a different presence or absence of a winding coil as compared to the first example embodiment. Accordingly, in describing the coil component 3000 according to this example embodiment, only a winding type coil different from the coil of the first example embodiment will be described. The description in the first example embodiment of the present disclosure may be applied to the remaining configurations of this example embodiment.

Referring to FIG. 15, a coil component 3000 according to a third example embodiment of the present disclosure may include a body 100, a winding coil 300, and external electrodes 400 and 500.

Referring to FIG. 15, the winding coil 300 is buried in the body 100. The winding coil 300 may be formed by winding a metal wire such as a copper wire having a surface covered with an insulating material in a spiral shape. The winding coil 300 also includes withdrawal portions 331 and 332 connected to the winding coil 300 and extending to a surface of a body 100. That is, the coil component 3000 according to the third example embodiment may be a winding type inductor.

Specifically, both ends of the winding coil 300 may be spirally formed and be connected to the first and second withdrawal portions 331 and 332. At least a portion of the first and second withdrawal portions 331 and 332 extend to the first and second recesses R1 and R2, respectively.

The description of the other configuration overlaps with the description in the first example embodiment, and will be omitted below.

### Fourth Example Embodiment

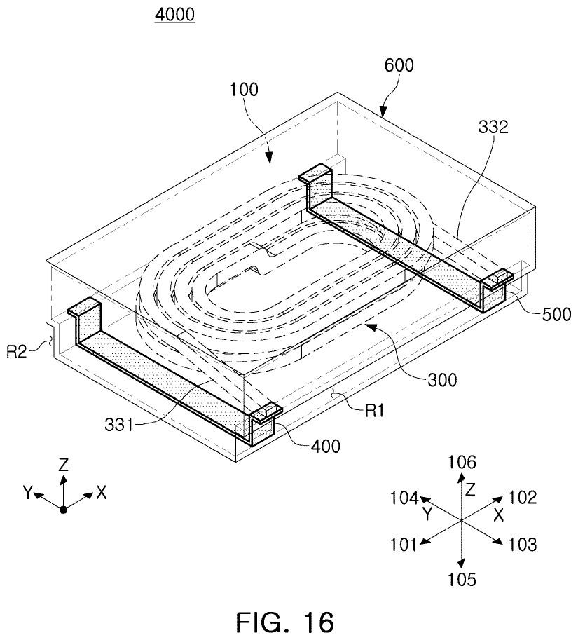

FIG. 16 is a diagram schematically illustrating a coil component according to a fourth example embodiment of the present disclosure.

Referring to FIG. 16, a coil component 4000 according to a fourth example embodiment of the present disclosure has a different presence or absence of a winding coil as compared to the second example embodiment. Accordingly, in describing the coil component 4000 according to this example embodiment, only a winding type coil different from the coil of the second example embodiment will be described. The description in the second example embodiment of the present disclosure may be applied to the remaining configurations of this example embodiment.

Referring to FIG. 16, a coil component 4000 according to a fourth example embodiment of the present disclosure may include a body 100, a winding coil 300, and external electrodes 400 and 500.

Referring to FIG. 16, the winding coil 300 is buried in the body 100. The winding coil 300 may be formed by winding a metal wire such as a copper wire having a surface covered with an insulating material in a spiral shape. The winding coil 300 also includes withdrawal portions 331 and 332 connected to the winding coil 300 and extending to a surface of a body 100. That is, the coil component 4000 according to the fourth example embodiment may be a winding type inductor.

Specifically, both ends of the winding coil 300 may be spirally formed and be connected to the first and second withdrawal portions 331 and 332. At least a portion of the first and second withdrawal portions 331 and 332 extend to the first recess R1, respectively.

The description of the other configuration overlaps with the description in the second example embodiment, and will be omitted below.

Although one example embodiment of the present disclosure has been described above, it will be apparent to those skilled in the art that modifications and variations could be made in various ways by adding, changing, or deleting components within the scope of the patent claim, without departing from the scope of the present disclosure as defined by the appended claims, and will also be included within the scope of the present disclosure.

What is claimed is:

1. A coil component comprising:
a body including a core, and a first surface and a second surface opposing each other in a first direction, a third surface and a fourth surface opposing each other in a second direction, and a fifth surface and a sixth surface opposing each other in a third direction, wherein first and second recesses are formed on the third surface and the fourth surface, respectively;
a coil disposed inside the body, and including a winding portion forming at least one turn using a core as an axis, and first and second withdrawal portions extending to at least one of a first recess or a second recess; and
a first external electrode disposed on the fifth surface of the body, extending to the first and second recesses, and connected to the first withdrawal portion; and
a second external electrode disposed on the fifth surface of the body, extending to the first and second recesses, and connected to the second withdrawal portion.

2. The coil component according to claim 1, wherein the first and second external electrodes are spaced apart from each other in the first direction of the body.

3. The coil component according to claim 1, wherein
at least a portion of the first withdrawal portion extend to the first recess, and
at least a portion of the second withdrawal portion and second recesses.

4. The coil component according to claim 3, wherein each of the first and second external electrodes includes an extension portion disposed on the fifth surface of the body, and a connection portion connected to the extension portion and disposed on internal surfaces of the first and second recesses,
the first withdrawal portion is in contact with the connection portion of the first external electrode disposed at the first recess, and
the second withdrawal portion is in contact with the connection portion of the second external electrode disposed at the second recess.

5. The coil component according to claim 1, wherein at least portion of the first withdrawal portion extends to the first recess.

6. The coil component according to claim 5, wherein each of the first and second external electrodes includes an extension portion disposed on the fifth surface of the body and a connection portion connected to the extension portion and disposed on internal surfaces of the first and second recesses to be connected to the coil, respectively,
the first withdrawal portion is connected to the connection portion of the first external electrode disposed at the first recess, and
the second withdrawal portion is connected to the connection portion of the second external electrode disposed at the first recess.

7. The coil component according to claim 1, wherein the withdrawal portion is disposed to be biased to one of the third surface and the fourth surface of the body, and
the withdrawal portion does not form a turn using the core as an axis.

8. The coil component according to claim 7, wherein the withdrawal portion is connected to the winding portion in the first direction of the body.

9. The coil component according to claim 8, wherein the withdrawal portion is parallel to the first surface of the body, and extends by a surface passing through a center of the core.

10. The coil component according to claim 7, wherein the withdrawal portion is connected to the winding portion in the second direction of the body.

11. The coil component according to claim 10, wherein the withdrawal portion is substantially parallel to the third surface of the body, and extends by a surface passing through a center of the core.

12. The coil component according to claim 1, further comprising:
a first insulating layer disposed on the body and the first and second external electrodes,
wherein the first insulating layer is disposed along internal surfaces of the first and second recesses, and covers connection portions of the first and second external electrodes, and exposes extension portions of each of the first and second external electrodes.

13. The coil component according to claim 1, further comprising:
a filling portion for filling at least a portion of the first and second recesses.

14. The coil component according to claim 1, further comprising:
a support substrate included in the body,
wherein the coil is formed on at least one surface of the support substrate.

15. The coil component according to claim 14, wherein the first and second withdrawal portions are disposed on one surface of the support substrate opposing the fifth surface of the body and are spaced apart from each other, and
the coil further comprises:
a first winding portion disposed on one surface of the support substrate and being contact with the first withdrawal portion, and spaced apart from the second withdrawal portion, and
a second winding portion disposed on the other surface opposing to the one surface of the support substrate, and a via penetrating through the support substrate to connect the first winding portion to the second winding portion.

16. The coil component according to claim 15, wherein the coil further comprises:
a first auxiliary withdrawal portion disposed on the other surface of the support substrate, and being contact with the second winding portion and connected to the second withdrawal portion.
